(19) United States
(12) Patent Application Publication
(10) Pub. No.: US 2026/0072476 A1
(43) Pub. Date: Mar. 12, 2026

(54) ELECTRONIC DEVICE INCLUDING REINFORCEMENT MEMBER

(71) Applicant: SAMSUNG ELECTRONICS CO., LTD., Suwon-si (KR)

(72) Inventors: Jungchul AN, Suwon-si (KR); Sangkyu KIM, Suwon-si (KR); Hosang NAM, Suwon-si (KR); Jongjin JEONG, Suwon-si (KR)

(21) Appl. No.: 19/327,035

(22) Filed: Sep. 12, 2025

Related U.S. Application Data
(63) Continuation of application No. PCT/KR2025/014257, filed on Sep. 12, 2025.

(30) Foreign Application Priority Data
Sep. 12, 2024 (KR) 10-2024-0124635
Oct. 25, 2024 (KR) 10-2024-0147670

(51) Int. Cl. G06F 1/16; G06F 1/18

(52) U.S. Cl. CPC G06F 1/1656; G06F 1/1652; G06F 1/1681; G06F 1/183

(57) ABSTRACT

An electronic device includes a housing forming an exterior of the electronic device, a display panel at the housing, a support plate below the display panel, facing the display panel and having a peripheral portion adjacent to an edge of the display panel, a flexible connection member including a flexible portion bent from the edge of the display pane, and an extending portion which extends from the flexible portion and is below the peripheral portion of the support plate, a waterproof strip between the extending portion and the peripheral portion of the support plate and extending along the peripheral portion of the support plate, and a reinforcement sheet between the extending portion and the peripheral portion of the support plate and extending along the waterproof strip. The reinforcement sheet includes a reinforcement material having a rigidity higher than a rigidity of the waterproof strip.

### CROSS-REFERENCE TO RELATED APPLICATIONS

This application is a continuation application of International Application No. PCT/KR2025/014257 designating the United States, filed on Sep. 12, 2025, in the Korean Intellectual Property Receiving Office and claiming priority to Korean Patent Application No. 10-2024-0124635 filed on Sep. 12, 2024 and to Korean Patent Application No. 10-2024-0147670 filed on Oct. 25, 2024 in the Korean Intellectual Property Office, the disclosures of which are incorporated by reference herein in their entireties.

### FIELD

Various embodiments disclosed herein relate to an electronic device. For example, various embodiments relate to an electronic device including a reinforcement member.

### DESCRIPTION OF THE RELATED ART

The term “electronic device” may refer to a device which performs a specific function based on an installed program, such as a home appliance, an electronic scheduler, a portable multimedia player, a mobile communication terminal, a tablet personal computer (PC), a video/audio device, a desktop/laptop PC, or a vehicle navigation system. For example, these electronic devices may output stored information as sound or images. As the degree of integration of electronic devices increases and ultra-high-speed and high-capacity wireless communication become more widespread, a single electronic device, such as a mobile communication terminal, may be now equipped with various functions. For example, not only communication functions but also entertainment functions such as gaming, multimedia functions such as music and video playback, communication and security functions for mobile banking, or functions of schedule management or electronic wallet are being integrated into a single electronic device.

As the use of personal or portable communication devices, such as smartphones, has become common, user demands for portability and ease of use are increasing. For example, a display of an electronic device may provide a virtual keypad which replaces a mechanical input device (e.g., a button-type input device) while serving as an output device which outputs an image (e.g., visual information). Accordingly, portable communication devices or electronic devices have come to be capable of providing the same or further improved usability (e.g., a larger screen) while being miniaturized.

### SUMMARY

An electronic device according to an embodiment of the disclosure may include a housing forming at least a portion of an exterior of the electronic device, a display panel disposed at the housing, a support plate, which is disposed below the display panel and faces the display panel, wherein the support plate has a peripheral portion adjacent to an edge of the display panel, a flexible connection member including a flexible portion, which is bent from the edge of the display panel, and an extending portion, which extends from the flexible portion and is positioned below the peripheral portion of the support plate, a waterproof strip disposed between the extending portion and the peripheral portion of the support plate and extending along the peripheral portion of the support plate, and a reinforcement sheet disposed between the extending portion and the peripheral portion of the support plate and extending along the waterproof strip. The reinforcement sheet may include a reinforcement material having a rigidity higher than a rigidity of the waterproof strip.

An electronic device according to an embodiment of the disclosure may include a housing forming at least a portion of an exterior of the electronic device, a display disposed at the housing, a display panel and a support plate, which is disposed below the display panel and supports the display panel, a flexible connection member including a flexible portion, which is bent from an edge of the display panel, and an extending portion, which extends from the flexible portion and is positioned below an edge of the support plate, a waterproof strip disposed between the extending portion and the edge of the support plate and extending along the support plate, a reinforcement sheet disposed between the extending portion and the edge of the support plate and extending along the edge of the waterproof strip, and a display drive integrated circuit positioned below the waterproof strip and connected to the display panel via the flexible connection member. The reinforcement sheet may be positioned between the flexible portion and the waterproof strip and may include a reinforcement material having a rigidity higher than that of the waterproof strip.

An electronic device according to an embodiment of the disclosure may include a housing forming a portion of an exterior of the electronic device, a display on the housing, the display comprising, a display panel having an edge, and a support plate which faces the display panel, is below the display panel and has an edge adjacent to the edge of the display panel, a flexible connection member connected to the display panel, the flexible connection member comprising, a flexible portion which extends bent from the edge of the display panel, and an extending portion which extends from the flexible portion and is below the support plate, between the extending portion of the flexible connection member and the support plate of the display, a reinforcement sheet extending along the edge of the display panel, and a waterproof strip which is further from the edge of the support plate than the reinforcement sheet and extends along the reinforcement sheet, wherein the reinforcement sheet comprises a material having a rigidity higher than a rigidity of the waterproof strip, and is between the waterproof strip and the flexible portion of the flexible connection member.

### BRIEF DESCRIPTION OF DRAWINGS

The above-described aspects or other aspects, configurations, and/or advantages regarding various embodiments of the disclosure may become more apparent through the following detailed description made with reference to the accompanying drawings.

FIG. 1 is a block diagram of an electronic device according to various embodiments in a network environment.

FIGS. 2A to 2B illustrate an electronic device according to an embodiment of the disclosure in an unfolded state.

FIGS. 3A to 3B illustrate the electronic device according to an embodiment of the disclosure in a folded state.

FIG. 4 is an exploded perspective view of an electronic device according to an embodiment of the disclosure.

FIG. 5 is a cross-sectional view of a display according to an embodiment of the disclosure.

FIG. 6 illustrates a portion of the display viewed from above, according to an embodiment of the disclosure.

FIG. 7 is a partial cross-sectional view of an electronic device taken along line A-A′ line indicated in FIG. 6.

FIG. 8 is an enlarged partial view of portion A in FIG. 7.

FIG. 9 is an enlarged partial view of portion B in FIG. 7.

FIG. 10 illustrates a portion of a support plate viewed from below, according to an embodiment of the disclosure.

FIG. 11 illustrates a housing viewed from above, according to an embodiment of the disclosure.

FIG. 12 illustrates a display viewed from below, according to an embodiment of the disclosure.

FIG. 13 is a cross-sectional view taken along line B-B′ of portion C in FIG. 12.

FIG. 14 is a cross-sectional view taken along line B-B′ of portion D in FIG. 12.

FIG. 15 illustrates a reinforcement sheet and a waterproof strip according to an embodiment of the disclosure.

FIG. 16 is an exploded perspective view of an electronic device according to an embodiment of the disclosure, viewed from above.

FIG. 17 is an exploded perspective view of an electronic device according to an embodiment of the disclosure, viewed from below.

### DETAILED DESCRIPTION

The following description with reference to the appended drawings may provide an understanding of various implementations of the disclosure, including the claims and their equivalents. An embodiment disclosed in the following description includes various specific details to help understanding, but is considered to be one of various embodiments. Accordingly, it will be understood by a person ordinarily skilled in the art that various implementations described herein may be variously changed and modified without departing from the scope and spirit of the disclosure. In addition, descriptions of well-known functions and configurations may be omitted for clarity and brevity.

The terms and words used in the following description and claims are not limited to a bibliographical meaning, but may be used to describe an embodiment of the disclosure clearly and consistently. Accordingly, it will be apparent to those skilled in the art that the following description of various implementations of the disclosure is provided for explanatory purposes and not intended to limit the scope of the disclosure and equivalents thereof.

Unless the context clearly indicates otherwise, the singular forms of “a,” “an,” and “the” should be understood to include the plural meaning. Accordingly, for example, the term “a component surface” may be understood to include one or more surfaces of the component.

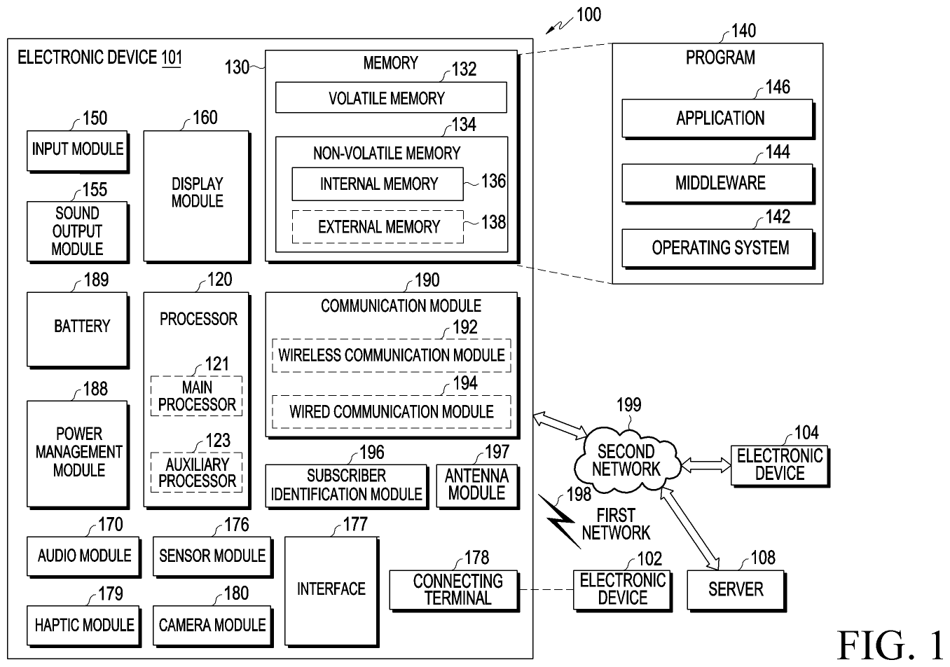

FIG. 1 is a block diagram illustrating an electronic device 101 in a network environment 100 according to various embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of Ims or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements.

It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases.

As used herein, such terms as “1st” and “2nd,” or “first” and “second” may be used to simply distinguish a corresponding component from another, and does not limit the components in other aspect (e.g., importance or order).

It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

It will be understood that when an element is referred to as being related to another element such as being “on” another element, it can be directly on the other element or intervening elements may be present therebetween. In contrast, when an element is referred to as being related to another element such as being “directly on” another element, there are no intervening elements present.

Furthermore, relative terms, such as “lower” or “bottom” and “upper” or “top,” may be used herein to describe one element's relationship to another element as illustrated in the Figures. It will be understood that relative terms are intended to encompass different orientations of the electronic device in addition to the orientation depicted in the Figures. For example, if the electronic device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

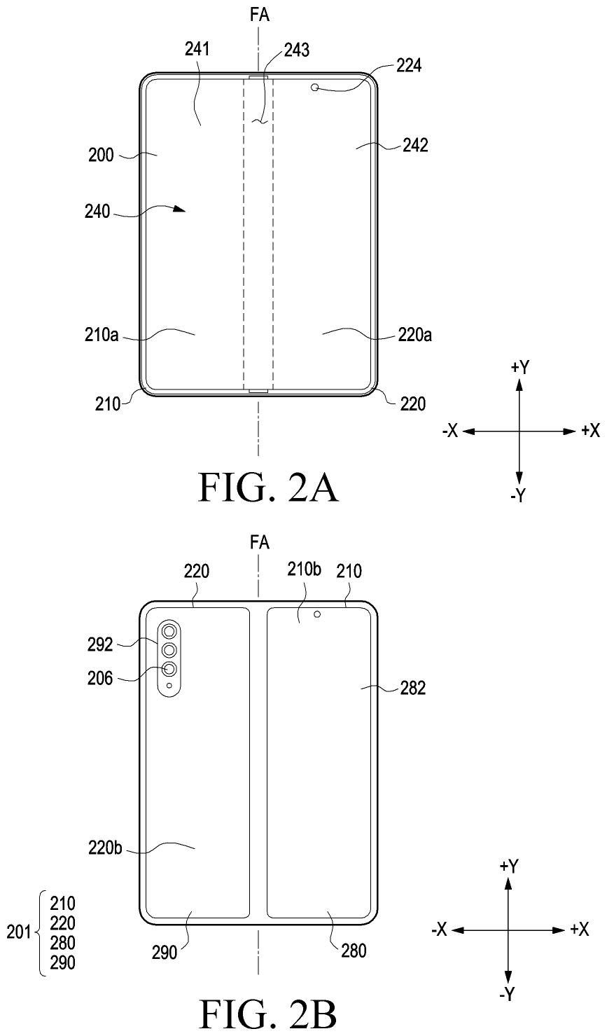

The description of the electronic device 101 described with reference to FIG. 1 may be substantially applicable to the electronic device 200 described with reference to FIGS. 2 to 17, to the extent that they are not contradictory to each other. For example, the description of the components of the electronic device 101 illustrated in FIG. 1 (e.g., the display module 160) may be substantially equally applicable to the components of the electronic device 200 described with reference to FIGS. 2 to 15 (e.g., the display 240).

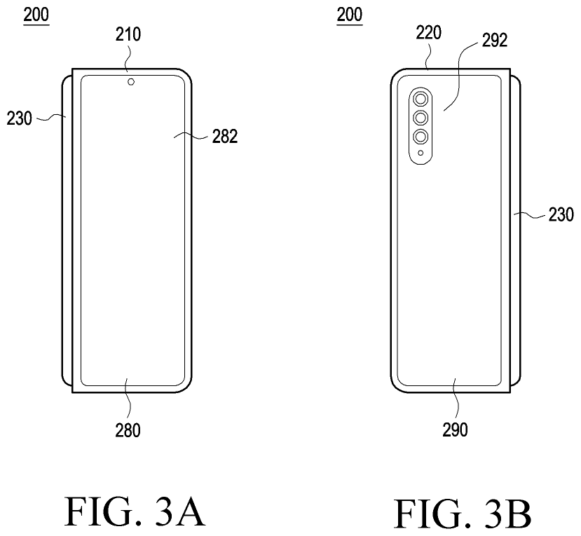

FIGS. 2A to 2B illustrate an electronic device 200 in an unfolded state, according to an embodiment of the disclosure. FIGS. 3A to 3B illustrate the electronic device 200 in a folded state, according to an embodiment of the disclosure. As used herein, one or more figures among FIGS. 2A-2B may be hereinafter referred to as “FIG. 2”. Similarly one or more figures among FIGS. 3A-3B may be hereinafter referred to as “FIG. 3.”

Referring to FIGS. 2 and 3, according to an embodiment of the disclosure, the electronic device 200 may include a set housing 201, a hinge cover 230 covering a foldable portion of the set housing 201, and a display 240 disposed on the set housing 201. The display 240 may be, for example, a flexible or foldable display. The display 240 may be referred to as a display stack.

According to an embodiment of the disclosure, a surface formed by the display 240 may be referred to as a front surface of the electronic device 200 (e.g., a first front surface 210a and a second front surface 220a). A surface opposite to the front surface may be referred to as a rear surface of the electronic device 200 (e.g., a first rear surface 210b and a second rear surface 220b). A surface connecting the front surface and the rear surface of the electronic device 200 and surrounding the space between the front surface and the rear surface of the device 200 may be referred to as a side surface of the electronic device 200.

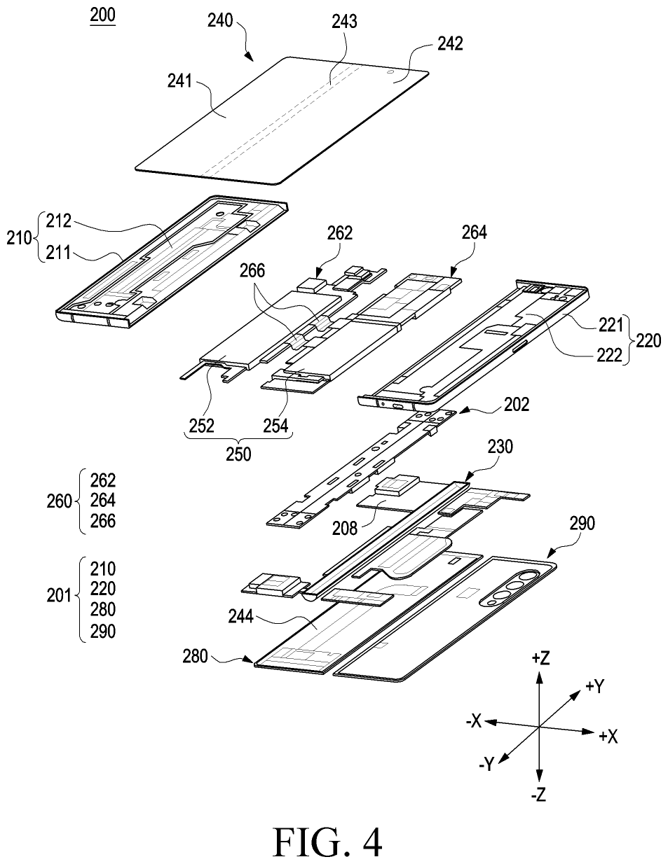

According to an embodiment of the disclosure, the set housing 201 may include a first housing 210, a second housing 220, a first rear surface cover 280, a second rear surface cover 290, and a hinge assembly (e.g., the hinge assembly 202 of FIG. 4) to which the first housing 210 and the second housing 220 are coupled. The hinge assembly 202 may provide a folding axis FA serving as a reference for folding or unfolding the electronic device 200. The set housing 201 of the electronic device 200 is not limited to the form illustrated in FIGS. 2 and 3 and may be implemented through other shapes, combinations, and/or assemblies of components. For example, in an embodiment, the first housing 210 and the first rear surface cover 280 may be integrally configured, or the second housing 220 and the second rear surface cover 290 may be integrally configured. The electronic device 200 may be transitioned between a folded state and an unfolded state by the hinge assembly 202. When the electronic device 200 is in the folded state, the first front surface 210a may face the second front surface 220a. When the electronic device 200 is in the unfolded state the first front surface 210a and the second front surface 220a may face the same direction. Hereinbelow, unless otherwise stated, directions will be described with reference to the state in which the electronic device 200 is unfolded.

According to an embodiment of the disclosure, the first housing 210 and the second housing 220 may be disposed on opposite sides of the hinge assembly 202 with respect to the folding axis FA. For example, the first housing 210 and the second housing 220 may have a substantially symmetrical shape with respect to the folding axis FA. According to an embodiment of the disclosure, the folding axis FA may be substantially parallel to a length direction of the electronic device 200 (e.g., a Y-axis direction), but the orientation of the folding axis FA is not limited thereto. According to an embodiment of the disclosure, the first housing 210 and the second housing 220 may be at least partially made of a metal or non-metal material having rigidity in a level selected to support the display 240. The at least a portion made of the metal material may provide a ground plane of the electronic device 200, and may be electrically connected to a ground conductor provided on a printed circuit board (e.g., the board unit 260 in FIG. 4).

According to an embodiment of the disclosure, the sensor area 224 may be provided to have a predetermined area adjacent to one corner of the second housing 220. However, the arrangement, shape, and size of the sensor area 224 are not limited to the illustrated example. According to an embodiment, components built into the electronic device 200 to perform various functions may be visually exposed on the front surface of the electronic device 200 through the sensor area 224 or through one or more openings provided in the sensor area 224. In various embodiments, the components may include various types of sensors. The sensors may include, for example, at least one of a front camera, a receiver, or a proximity sensor.

According to an embodiment of the disclosure, the first rear surface cover 280 may be disposed on one side of the folding axis FA. An edge of the first rear surface cover 280 may be supported by the first housing 210. The second rear surface cover 290 may be disposed on the other side of the folding axis FA. An edge of the second rear surface cover 290 may be supported by the second housing 220.

According to an embodiment of the disclosure, the first rear surface cover 280 and the second rear surface cover 290 may have substantially symmetrical shapes with respect to the folding axis FA. However, the first rear surface cover 280 and the second rear surface cover 290 do not necessarily have mutually symmetrical shapes, and in an embodiment, the electronic device 200 may include a first rear surface cover 280 and a second rear surface cover 290 having various shapes.

According to an embodiment of the disclosure, the first rear surface cover 280, the second rear surface cover 290, the first housing 210, and the second housing 220 may together define a space in which components of the electronic device 200 (e.g., a printed circuit board or a battery) are accommodated. According to an embodiment, one or more components may be disposed or visually exposed at the rear surface of the foldable electronic device 200. For example, at least a portion of the sub-display (e.g., the sub-display 244 in FIG. 4) may be visually exposed through the first rear surface area 282 of the first rear surface cover 280. Alternatively, the first rear surface cover 280 may be replaced with a sub-display 244. In an embodiment, one or more components or sensors may be visually exposed through a second rear surface area 292 of the second rear surface cover 290. In various embodiments, the sensors may include a proximity sensor and/or a camera module 206 (e.g., a rear camera).

According to an embodiment of the disclosure, a front camera, which is visually exposed to the front surface of the electronic device 200 through one or more openings provided in the sensor area 224, or a camera module 206, which is visually exposed through the second rear surface area 292 of the second rear surface cover 290, may include one or more lenses, an image sensor, and/or an image signal processor. In some embodiments, two or more lenses (e.g., an infrared camera lens, a wide-angle lens, and a telephoto lens) and image sensors may be disposed on one surface of the electronic device 200.

Referring to FIG. 3, according to an embodiment, the hinge cover 230 is disposed between the first housing 210 and the second housing 220 and may cover internal components (e.g., the hinge assembly 202 in FIG. 4). According to an embodiment, the hinge cover 230 may be covered by a portion of the first housing 210 and a portion of the second housing 220 or exposed to the outside depending on the state of the electronic device 200 (the unfolded state or the folded state). For example, in the unfolded state of the electronic device 200, the hinge cover 230 may be substantially covered by the first housing 210 and the second housing 220, whereas in the folded state, the outer surface of the hinge cover 230 may be exposed to the outside (e.g., outside of the electronic device 200).

According to an embodiment of the disclosure, the display 240 may be disposed at the set housing 201. For example, the display 240 may be seated on a recess defined by the set housing 201 and may form at least a portion of the front surface of the electronic device 200.

According to an embodiment of the disclosure, the display 240 may include a first display area 241 disposed on the first housing 210 and a second display area 242 disposed on the second housing 220. The display 240 may include a flexible folding area 243 connecting the first display area 241 and the second display area 242 to each other.

According to an embodiment of the disclosure, the first display area 241 and the second display area 242 may have substantially symmetrical shapes with respect to the folding area 243. According to an embodiment (not illustrated), unlike the first display area 241, the second display area 242 may include a notch cut due to the presence of the sensor area 224, but may have a shape symmetrical to the first display area 241 in areas other than the sensor area. In other words, the first display area 241 and the second display area 242 may include portions having symmetrical shapes and portions having asymmetrical shapes.

FIG. 4 is an exploded perspective view of an electronic device 200 according to an embodiment of the disclosure.

Referring to FIG. 4, the electronic device 200 may include a set housing 201, a display 240, a hinge assembly 202, a battery 250, and/or a board unit 260. The set housing 201 may include a first housing 210, a second housing 220, a first rear surface cover 280, and/or a second rear surface cover 290.

According to an embodiment of the disclosure, the set housing 201 may include a first housing 210, a second housing 220, a hinge cover 230, a first rear surface cover 280, and/or a second rear surface cover 290. In an embodiment, a hinge assembly 202 may be disposed inside the set housing 201 to rotatably connect the first housing 210 and the second housing 220 to each other. The first housing 210 and the second housing 220 may be respectively coupled to opposing sides of the hinge assembly 202.

According to an embodiment, the first housing 210 may include a first support bracket 212 capable of supporting components of the electronic device 200 (e.g., a first circuit board 262 and/or a first battery 252). The first support bracket 212 may be referred to as a first support plate or a first plate portion. The first housing 210 may include a first side wall 211 extending along the edge of the first support bracket 212.

According to an embodiment, the second housing 220 may include a second support bracket 222 capable of supporting components of the electronic device 200 (e.g., a second circuit board 264 and/or a second battery 254). The second support bracket 222 may be referred to as a second support plate or a second plate portion. The second housing 220 may include a second side wall 221 surrounding at least a portion of the second support bracket 222. The second side wall 221 may extend along the edge of the second support bracket 222. The second side wall 221 may include (or define) a second side surface of the electronic device 200.

According to an embodiment of the disclosure, the electronic device 200 may include a display 240 and a sub-display 244. The description of the display 240 described with reference to FIGS. 2 and 3 (e.g., the first display area 241, the second display area 242, and the folding area 243) may be substantially equally applicable to the sub-display 244 illustrated in FIG. 4, to the extent that they are not contradictory to each other.

According to an embodiment of the disclosure, the sub-display 244 may display information in a direction different from the display areas 241 and 242. For example, the sub-display 244 may output an image in a direction opposite to the first display area 241. According to an embodiment, the sub-display 244 may be disposed on the first rear side cover 280.

According to an embodiment of the disclosure, the battery 250 may include a first battery 252 disposed in the first housing 210 and a second battery 254 disposed in the second housing 220. According to an embodiment, the first battery 252 may be disposed on the first circuit board 262, and the second battery 254 may be disposed on the second circuit board 264.

According to an embodiment of the disclosure, the board unit 260 may include the first circuit board 262 disposed within the first housing 210 and the second circuit board 264 disposed within the second housing 220. According to an embodiment, the board unit 260 may include at least one flexible printed circuit board 266 for electrically connecting the first circuit board 262 and the second circuit board 264. The flexible printed circuit board 266 may be disposed across the hinge assembly 202. The flexible printed circuit board 266 may be disposed across the folding axis FA. According to an embodiment, the first circuit board 262 and the second circuit board 264 may be disposed inside a space defined by the first housing 210, the second housing 220, the first rear side cover 280, and the second rear side cover 290. Components for implementing various functions of the electronic device 200 may be mounted on and/or electrically connected to the first circuit board 262 and the second circuit board 264.

According to an embodiment of the disclosure, the electronic device 200 may include a speaker module 208 (e.g., the audio module 170 of FIG. 1). According to an embodiment, the speaker module 208 may convert an electrical signal into sound. According to an embodiment, the speaker module 208 may be disposed inside the space defined by the first housing 210, the second housing 220, the first rear surface cover 280, and the second rear surface cover 290.

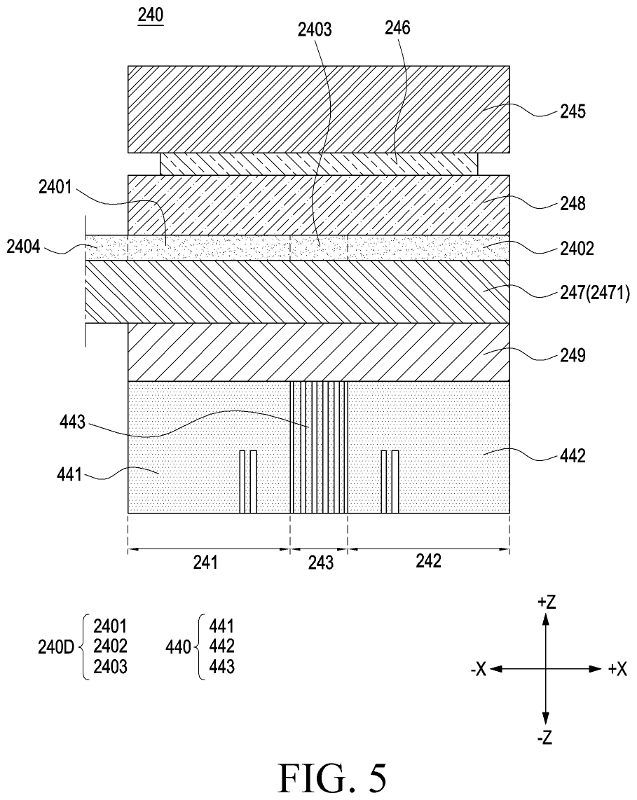

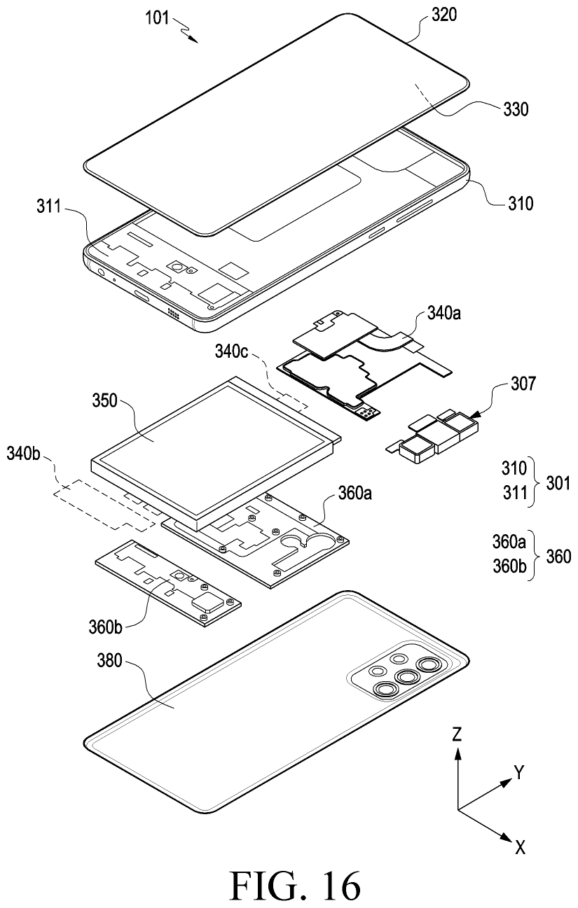

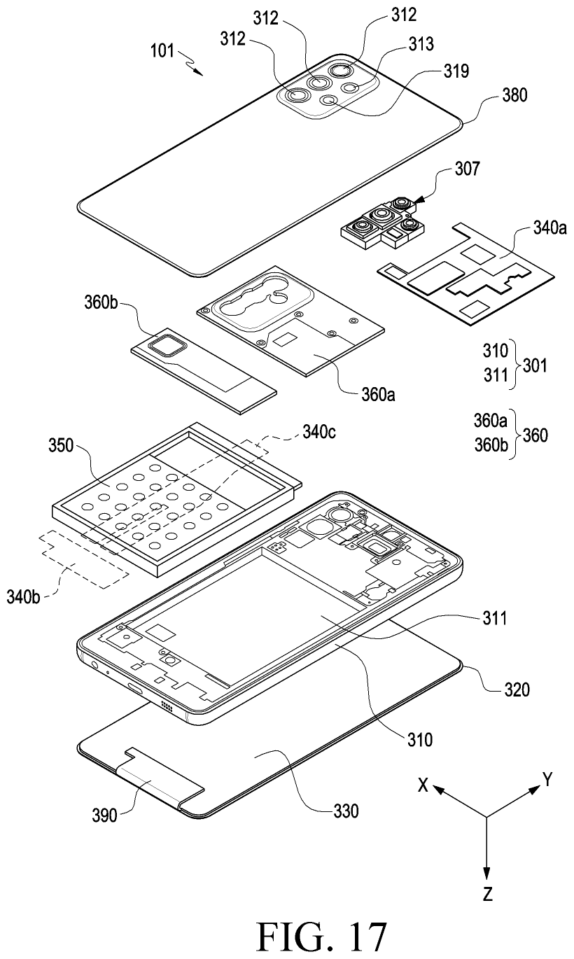

FIGS. 2 to 4 illustrate an electronic device 200 including a hinge assembly 202. The electronic device 200 may transition between a folded state and an unfolded state by the operation of the hinge assembly 202, but these are merely exemplary. The description of the disclosure provided below with reference to FIGS. 5 to 17 may be understood as being unrelated to the hinge assembly 202 illustrated in FIGS. 2 to 4. An electronic device which does not include the hinge assembly 202 will be described in more detail below with reference to FIGS. 16 and 17.

FIG. 5 is a cross-sectional view of a display 240 illustrating layers included in the display 240 according to an embodiment of the disclosure.

Referring to FIG. 5, according to an embodiment of the disclosure, the electronic device 200 may include a display 240 disposed on the first housing 210 (e.g., the display module 160 of FIG. 1). The display 240 may be configured to display visual information. The display 240 may be exposed to the exterior of the electronic device 200. The display 240 may be supported by the set housing 201 (e.g., the first support bracket 212 or the second support bracket 222 of FIG. 4). For example, the display 240 may be referred to as a “display stack,” in which multiple display layers 240D, 245, 246, 247, 248, 249, and 440 are stacked.

According to an embodiment of the disclosure, the display 240 may include a display panel 240D. The display panel 240D may include a first active portion 2401 positioned in the first display area 241. The display panel 240D may include a second active portion 2402 positioned in the second display area 242. The display panel 240D may include a third active portion 2403 positioned in the folding area 243. The active portions 2401, 2402, and 2403 of the display panel 240D may be display areas in which pixels are arranged and may include areas for displaying the visual information.

According to an embodiment of the disclosure, the display 240 may include a flexible portion 2404 extending from the display panel 240D. For example, the flexible portion 2404 may include an area which does not include pixels for displaying an image. The flexible portion 2404 may be referred to as a non-active portion (or non-display area) of the display panel 240D. For example, the flexible portion 2404 may be configured integrally with the display panel 240D. According to an embodiment (not illustrated), the flexible portion 2404 may be implemented as a connection member connected to an edge of the display panel 240D (e.g., the first active portion 2401). For example, the flexible portion 2404 may be a flexible substrate connected to an edge of the display panel 240D (e.g., the first active portion 2401).

According to an embodiment of the disclosure, the display 240 may include a protective window 246. For example, the protective window 246 may cover (or overlap) the active areas 2401, 2402, and 2403 of the display panel 240D. The protective window 246 may be adhered to the active areas 2401, 2402, and 2403 of the display panel 240D via an adhesive layer 248. For example, the thickness of the protective window 246 may be about 60 μm.

According to an embodiment of the disclosure, the display 240 may include a polarizer 245. The polarizer 245 may cover the protective window 246. The polarizer 245 may be adhered to the protective window 246 via an adhesive layer (not illustrated). The polarizer 245 may improve the quality of an image displayed from the display panel 240D and viewed from outside the electronic device 200 such as by a user.

According to an embodiment of the disclosure, the display 240 may include a protective film 247 configured to protect the display panel 240D. The protective film 247 may be adhered to the bottom surface of the display panel 240D. The protective film 247 may support the display panel 240D. The protective film 247 may protect the display panel 240D from impacts applied from below the display panel 240D. The protective film 247 may include a first portion 2471 which supports and overlaps the active areas 2401, 2402, and 2403 of the display panel 240D. For example, the thickness of the protective film 247 may be about 75 μm.

According to an embodiment of the disclosure, the display 240 may include a cover panel 249 configured to protect the display panel 240D. The cover panel 249 may be positioned between the protective film 247 and the support plate 440. The cover panel 249 may be positioned below the display panel 240D. The cover panel 249 may support the display panel 240D. The cover panel 249 may have a rigidity higher than that of the protective film 247. The cover panel 249 may be omitted from the display 240 depending on design requirements.

According to an embodiment of the disclosure, the display 240 may include a support plate 440 positioned below the display panel 240D. The support plate 440 may include a peripheral portion adjacent to the edge of the display panel 240D. The support plate 440 may support the display panel 240D. The support plate 440 may face the display panel 240D. The support plate 440 may be configured to fold or unfold together with the display panel 240D. For example, the support plate 440 may include titanium and may have a thickness of about 120 μm.

According to an embodiment of the disclosure, the support plate 440 may include a first panel portion 441 positioned in the first display area 241. The first panel portion 441 may support the first active area 2401 of the display panel 240D. The support plate 440 may include a second panel portion 442 positioned in the second display area 242. The second panel portion 442 may support the second active area 2402 of the display panel 240D.

According to an embodiment of the disclosure, the support plate 440 may include a lattice portion 443 defined therein and positioned in the folding area 243. The lattice portion 443 may support the flexible third active area 2403 of the display panel 240D. The lattice portion 443 may include multiple slits. The multiple slits positioned in the lattice portion 443 may extend along the folding axis FA of the electronic device 200 (see FIG. 2). By including the multiple slits, the lattice portion 443 may be configured to fold or unfold together with the third active area 2403 of the display panel 240D.

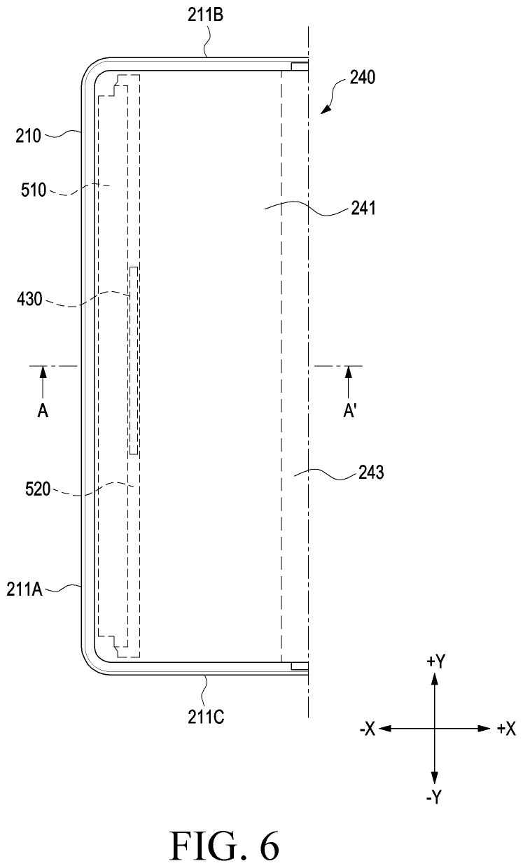

FIG. 6 illustrates a top view of a portion of the display 240 (e.g., the first display area 241) according to an embodiment of the disclosure. FIG. 6 illustrates a reinforcement sheet 510 and a waterproof strip 520 positioned below an edge (e.g., an outer edge or an edge surface) of the display panel 240D. Each of the reinforcement sheet 510 and the waterproof strip 520 may have a strip shape extended along the edge of the display panel 240D.

Referring to FIGS. 5 and 6, according to an embodiment of the disclosure, the electronic device 200 may include a first housing 210 (e.g., the set housing 201 of FIGS. 2 to 4) forming at least a portion of an exterior of the electronic device 200. The display 240 may be disposed at the first housing 210. The display 240 may be supported by the first housing 210.

According to an embodiment of the disclosure, the side wall 211 of the first housing 210 (see FIG. 4) may include a first side wall 211A, a second side wall 211B connected to the first side wall 211A and extending in a direction intersecting the first side wall 211A, and a third side wall 211C. For example, the first side wall 211A and the second side wall 211B may be substantially perpendicular to each other, and the first side wall 211A and the third side wall 211C may be substantially perpendicular to each other. The first side wall 211A, the second side wall 211B, and/or the third side wall 211C may extend along an edge (e.g., an outer edge) of the display 240.

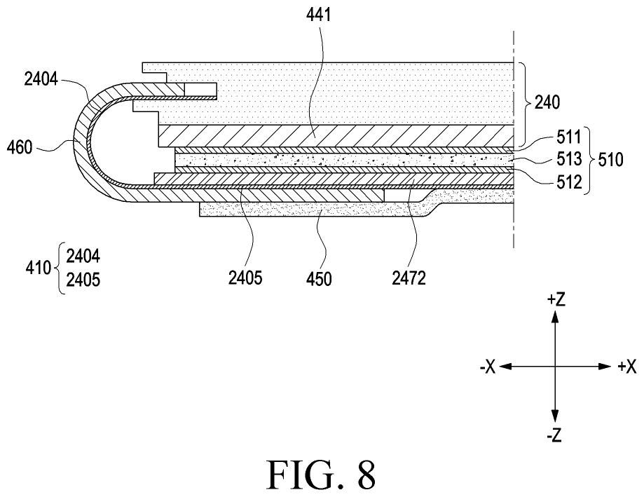

According to an embodiment of the disclosure, the electronic device 200 may include a reinforcement member 510 configured to reinforce the rigidity of an edge of the display 240. The reinforcement member 510 may be referred to as a reinforcement sheet. The reinforcement sheet 510 may be positioned below an edge of the display panel 240D to which the flexible portion 2404 of the flexible connection member 410 is connected (see FIG. 8).

The reinforcement sheet 510 may support the edge of the display panel 240D to which the flexible portion 2404 of the flexible connection member 410 is connected. The reinforcement sheet 510 may extend along the edge of the display 240 to which the flexible portion 2404 of the flexible connection member 410 is connected. The reinforcement sheet 510 may extend along the waterproof strip 520. The reinforcement sheet 510 may extend side by side adjacent to the waterproof strip 520. The reinforcement sheet 510 may be referred to as a reinforcement strip.

According to an embodiment of the disclosure, the electronic device 200 may include a waterproof strip 520 to prevent liquid penetration. The waterproof strip 520 may extend along an edge of the first housing 210. The waterproof strip 520 may extend along the first side wall 211A of the first housing 210. The waterproof strip 520 may extend along the reinforcement sheet 510.

According to an embodiment of the disclosure, the reinforcement sheet 510 may be positioned between the first side wall 211A of the housing 210 and the waterproof strip 520. The reinforcement sheet 510 may be positioned closer to the first side wall 211A of the first housing 210 than the waterproof strip 520. By being disposed closer to the side wall of the first housing 210 (e.g., the first side wall 211A), the reinforcement sheet 510 may reinforce the rigidity of the edge of the display 240, which is vulnerable to external impacts.

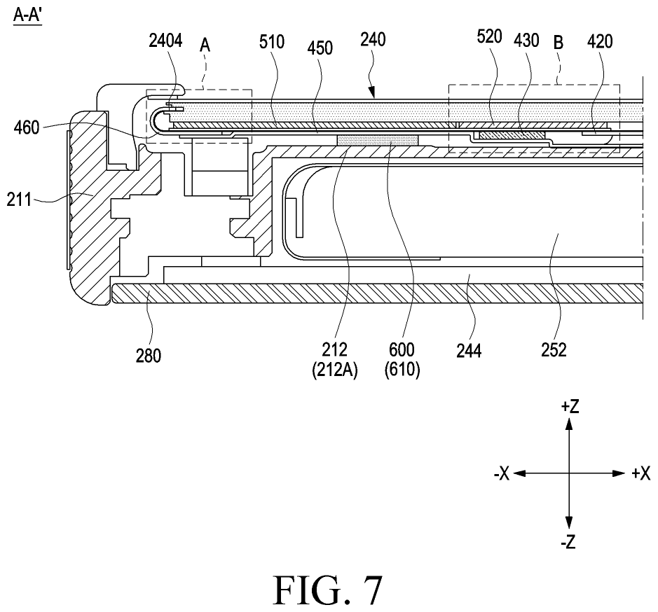

According to an embodiment of the disclosure, the reinforcement sheet 510 may have a rigidity higher than that of the waterproof strip 520. For example, the reinforcement sheet 510 having a rigidity higher than that of the waterproof strip 520 may mean that, when the same external force is applied, the reinforcement sheet 510 is less likely to deform compared to the waterproof strip 520. Components included in the reinforcement sheet 510 and the waterproof strip 520 will be described in detail with reference to FIGS. 7 to 9.

According to an embodiment of the disclosure, the electronic device 200 may include a display drive integrated circuit 430 configured to drive pixels of the display panel 240D. The display drive integrated circuit 430 may be electrically connected to the display panel 240D via a flexible connection member 410 (see FIG. 8). For example, by mounting the display drive integrated circuit 430 on the flexible portion 2404 (see FIG. 8) connected to the display panel 240D, the display drive integrated circuit 430 may be connected to the display panel 240D.

According to an embodiment of the disclosure, along a thickness direction of the display panel 240D, the waterproof strip 520 may be positioned between the display drive integrated circuit 430 and the waterproof strip 520. For example, when viewed from above the display 240 (e.g., the first display area 241 or the display panel 240D), the display drive integrated circuit 430 may overlap the waterproof strip 520. When viewed from above the display 240 (e.g., the first display area 241 or the display panel 240D), the display drive integrated circuit 430 may not overlap the reinforcement sheet 510. Accordingly, by disposing the display drive integrated circuit 430 to overlap the waterproof strip 520, which has relatively low rigidity, the waterproof strip 520 may serve as a buffer to protect the display drive integrated circuit 430 when an external impact is applied to the display 240.

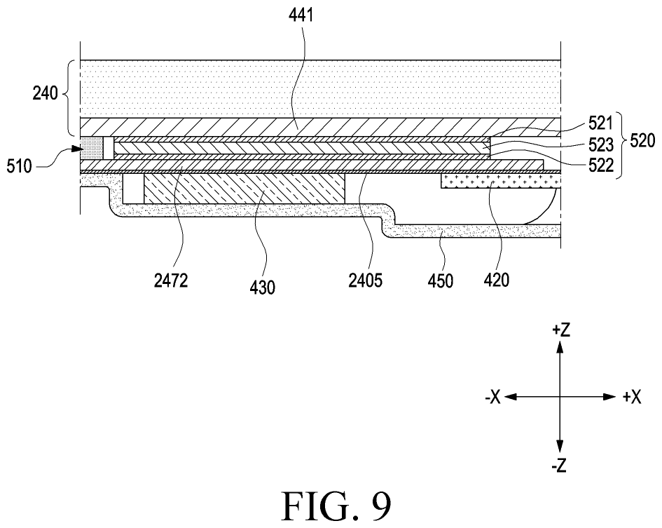

FIG. 7 is a partial cross-sectional view of the electronic device 200 taken along line A-A′ line indicated in FIG. 6. FIG. 8 is an enlarged partial view of portion A in FIG. 7. FIG. 9 is an enlarged partial view of portion B in FIG. 7.

Referring to FIGS. 7 to 9, according to an embodiment of the disclosure, the electronic device 200 may include a flexible connection member 410 electrically connected to an edge of the display 240 and configured to transmit signals to the display panel 240D. The flexible connection member 410 may extend from the edge of the display panel 240D. The flexible connection member 410 may be bent from the edge of the display panel 240D toward a space below the edge of the display panel 240D.

According to an embodiment of the disclosure, the flexible connection member 410 may include a flexible portion 2404 bent from the edge of the display panel 240D (see FIG. 5). The flexible connection member 410 may include signal lines connected to the display panel 240D. The flexible portion 2404 of the flexible connection member 410 may be bent from the edge of the display panel 240D (see FIG. 5) toward the space below the edge of the display panel 240D. The flexible connection member 410 may include an extending portion 2405 extending from the flexible portion 2404. The extending portion 2405 may be positioned below the support plate 440. The extending portion 2405 may be positioned below the peripheral portion of the support plate 440.

According to an embodiment of the disclosure, the flexible portion 2404 of the flexible connection member 410 may be positioned inside the side wall 211 (e.g., the first side wall 211A) of the first housing 210 (see FIG. 6). The display drive integrated circuit 430 may be connected to the extending portion 2405 of the flexible connection member 410. For example, the display drive integrated circuit 430 may be disposed on the extending portion 2405 and electrically connected to the extending portion 2405.

According to an embodiment of the disclosure, the electronic device 200 may include a protective cover 460 covering the flexible portion 2404 of the flexible connection member 410. The protective cover 460 may protect the flexible portion 2404, which is outwardly convexly curved. The protective cover 460 may be positioned between the side wall 211 (e.g., the first side wall 211A of FIG. 6) of the first housing 210 (see FIG. 6) and the flexible portion 2404.

According to an embodiment of the disclosure, the electronic device 200 may include a flexible printed circuit board 420 connected to the extending portion 2405 of the flexible connection member 410. The flexible printed circuit board 420 may be positioned below the display 240. The flexible connection member 410 may be connected to a circuit board disposed inside the electronic device 200 (e.g., the first circuit board 262 and/or the second circuit board 264 (see FIG. 4)) via the flexible printed circuit board 420.

According to an embodiment of the disclosure, the electronic device 200 may include a shielding film 450 as an electromagnetic shielding layer. For example, the shielding film 450 may be disposed on the extending portion 2405 of the flexible connection member 410. The shielding film 450 may cover the display drive integrated circuit 430. By the shielding film 450, electromagnetic waves generated from the display drive integrated circuit 430 may be prevented from causing noise in surrounding electronic components, and electromagnetic waves from external sources may be blocked from entering the display drive integrated circuit 430. For example, one side of the shielding film 450 and one side of the protective cover 460 may overlap each other.

According to an embodiment of the disclosure, the protective film 247 (see FIG. 5) of the display 240 may include a first protective film 2471 supporting the display panel 240D (see FIG. 5) and a second protective film 2472 supporting the extending portion 2405 of the flexible connection member 410. The first protective film 2471 and the second protective film 2472 may be spaced apart from each other. The first protective film 2471 may be adhered to the display panel 240D. The second protective film 2472 may be adhered to the extending portion 2405 of the flexible connection member 410.

According to an embodiment of the disclosure, the reinforcement sheet 510 may support an edge of the support plate 440 (see FIG. 5) (e.g., the first panel portion 441). The reinforcement sheet 510 may be disposed between the extending portion 2405 and the peripheral portion of the support plate 440. The reinforcement sheet 510 may be compressed between the extending portion 2405 and the edge of the support plate 440. For example, the reinforcement sheet 510 may include a plurality of layers 511, 512, and 513.

According to an embodiment of the disclosure, the reinforcement sheet 510 may include a reinforcement layer 513 including a reinforcement material. The reinforcement layer 513 containing the reinforcement material may include, for example, a metal material such as stainless steel or a thermoplastic material such as polyethylene terephthalate (PET). The reinforcement material may have a rigidity higher than that of the waterproof strip 520.

According to an embodiment of the disclosure, the support plate 440 may include a rigid material having a density lower than that of the reinforcement material. The reinforcement material may have a yield strength higher than that of the rigid material. For example, the reinforcement layer 513 including the reinforcement material may include stainless steel, and the rigid material may include titanium.

When the reinforcement layer 513 is absent, the support plate 440 may be deformed by an external impact, which may degrade the surface quality of the display 240 visually exposed to the outside of the electronic device 200. However, according to an embodiment of the disclosure, since an external impact may be partially absorbed by the rigidity of the reinforcement layer 513, the rigidity of the electronic device 200 may be reinforced, and the deformation of the display 240 (or the support plate 440) may be reduced.

According to an embodiment of the disclosure, the reinforcement sheet 510 may include a first adhesive layer 511 and a second adhesive layer 512. Via the first adhesive layer 511 and the second adhesive layer 512, the reinforcement sheet 510 may be adhered to the edge of the support plate 440 and the second protective film 2472. Via the first adhesive layer 511, the reinforcement layer 513 may be adhered between the edge of the first panel portion 441 of the support plate 440. Via the second adhesive layer 512, the reinforcement layer 513 may be adhered to the second protective film 2472. The reinforcement sheet 510 may be positioned between the flexible portion 2404 and the waterproof strip 520. The reinforcement sheet 510 is positioned between the flexible portion 2404 and the waterproof strip 520 in an extending direction of the display panel 240D.

According to an embodiment of the disclosure, the waterproof strip 520 may support the edge of the support plate 440 (see FIG. 5) (e.g., the first panel portion 441). The waterproof strip 520 may be positioned farther from the peripheral portion of the support plate 440 than the reinforcement sheet 510. The waterproof strip 520 may be disposed between the extending portion 2405 and the peripheral of the support plate 440. The waterproof strip 520 may be compressed between the extending portion 2405 and the edge of the support plate 440. The waterproof strip 520 may include a plurality of layers 521, 522, and 523.

According to an embodiment of the disclosure, the waterproof strip 520 may include an elastic layer 523 having a rigidity lower than that of the reinforcement layer 513 and an elasticity higher than that of the reinforcement layer 513. For example, the display drive integrated circuit 430 may be positioned below the elastic layer 523. When viewed from above the display 240, the display drive integrated circuit 430 and the elastic layer 523 of the waterproof strip 520 may overlap each other.

According to an embodiment of the disclosure, the elastic layer 523 may be formed as a single layer having a rigidity lower than that of the reinforcement layer 513 and an elasticity higher than that of the reinforcement layer 513. Alternatively, the elastic layer 523 may be formed by stacking a layer having a rigidity lower than that of the reinforcement layer 513 (e.g., a cushion layer) and a layer having an elasticity higher than that of the reinforcement layer 513 (e.g., the PET).

According to an embodiment of the disclosure, the waterproof sheet 520 may include a first adhesive layer 521 and a second adhesive layer 522. Via the first adhesive layer 521 and the second adhesive layer 522, the waterproof sheet 520 may be adhered between the edge of the support plate 440 and the second protective film 2472. The elastic layer 523 may be adhered to the edge of the first panel portion 441 of the support plate 440 via the first adhesive layer 521. The elastic layer 523 may be adhered to the second protective film 2472 via the second adhesive layer 522.

According to an embodiment of the disclosure, the reinforcement sheet 510 and the waterproof strip 520 may be positioned between the edge of the display 240 and the flexible connection member 410, which extends from the display 240 and is bent toward a space below the edge of the display 240. The reinforcement sheet 510 may be positioned coplanar with the waterproof strip 520. The waterproof strip 520 may be spaced apart inwardly (e.g., in the +X-axis direction) from the reinforcement sheet 510. The reinforcement sheet may have a first end 510A and a second end 510B corresponding to a first end 520A and a second end 520B of the waterproof strip 520. When viewed from above the display 240, the first end 520A and the second end 520B of the waterproof strip 520 may partially surround the first end 510A and the second end 510B of the reinforcement sheet 510. For example, the waterproof strip 520 may surround one side of the reinforcement sheet 510.

According to an embodiment of the disclosure, the electronic device 200 may reduce deformation of the display 240 by positioning the reinforcement sheet 510 in an area of the display 240 adjacent to an end area of the electronic device 200 vulnerable to external impacts (e.g., the first side wall 211A of FIG. 6). In addition, by disposing the waterproof strip 520 in an area overlapping the display drive integrated circuit 430, the effect of protecting the display driving integrated circuit 430 and ensuring waterproof performance may be achieved.

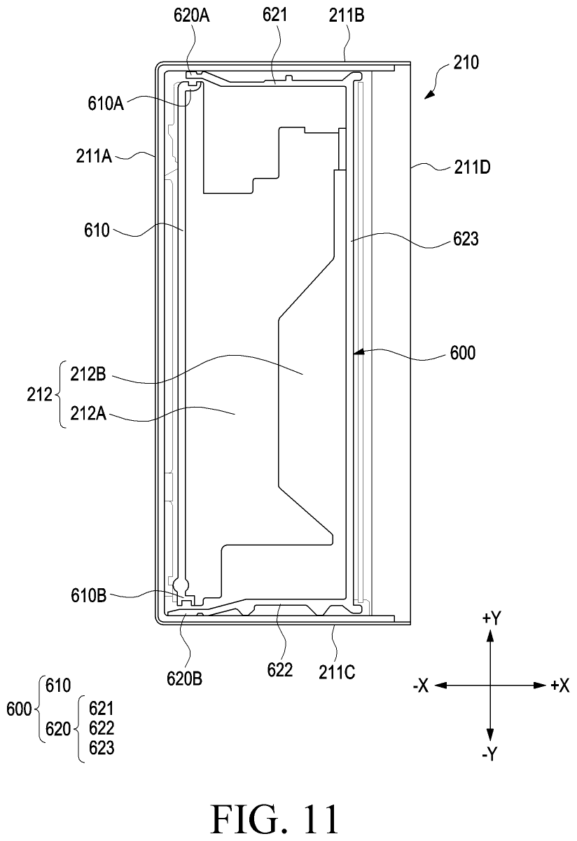

According to an embodiment of the disclosure, the first housing 210 of the electronic device 200 may include a side wall 211 and a support bracket 212. For example, the support bracket 212 may be positioned below the display 240. The display 240 (e.g., the first display area 241 of FIG. 4) may be supported by the support bracket 212. The support bracket 212 may include a first area 212A and a second area 212B. The first area 212A and the second area 212B of the support bracket 212 will be described in detail with reference to FIGS. 11 to 14.

According to an embodiment of the disclosure, the electronic device 200 may include a waterproof loop 600. FIG. 7 illustrates a waterproof loop 600 and a first waterproof segment 610, which is a portion of the waterproof loop 600. The first waterproof segment 610 of the waterproof loop 600 may be disposed between the support bracket 212 and the extending portion 2405 of the flexible connection member 410. The waterproof loop 600 will be described in detail with reference to FIGS. 11 to 14.

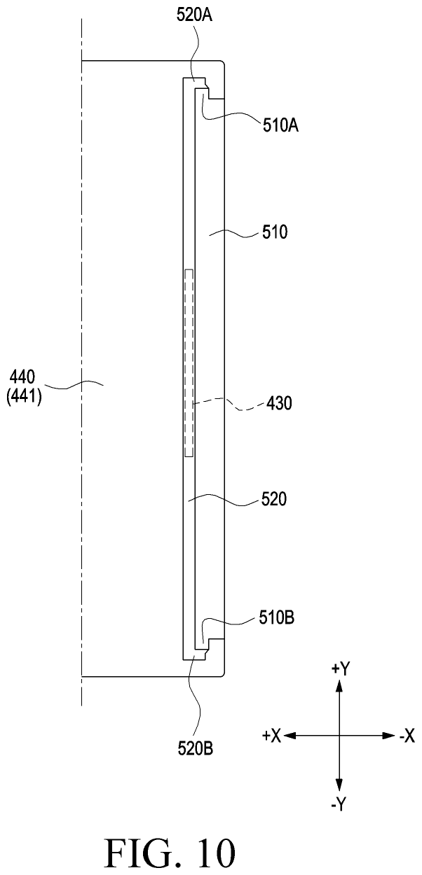

FIG. 10 illustrates a portion 441 of the support plate 440 viewed from below (e.g., in the +Z-axis direction), showing a state in which the reinforcement sheet 510 and the waterproof strip 520 are disposed on the bottom surface of the support plate 440.

Referring to FIG. 10, according to an embodiment of the disclosure, the reinforcement sheet 510 and the waterproof strip 520 may extend along the edge of the support plate 440. The waterproof strip 520 may extend along the inner side of the reinforcement sheet 510. The waterproof strip 520 may be spaced apart from the edge of the support plate 440. When viewed from below the support plate 440, the reinforcement sheet 510 may be positioned between the waterproof strip 520 and the edge of the support plate 440.

According to an embodiment of the disclosure, the ends 520A and 520B of the waterproof strip 520 may partially surround the ends 510A and 510B of the reinforcement sheet 510. The ends 520A and 520B of the waterproof strip 520 may extend (or protrude) in a direction intersecting the length direction of the waterproof strip 520 (e.g., the Y-axis direction in FIG. 6). For example, the ends 520A and 520B of the waterproof strip 520 may extend (or protrude) in a direction perpendicular to the length direction of the waterproof strip 520 (e.g., the Y-axis direction in FIG. 6). The ends 510A and 510B of the reinforcement sheet 510 and the ends 520A and 520B of the waterproof strip 520 may be understood as end portions in the length directions thereof. Accordingly, liquid inflowing through an area adjacent to the ends 510A and 510B of the reinforcement sheet 510 may be blocked by the ends 520A and 520B of the waterproof strip 520.

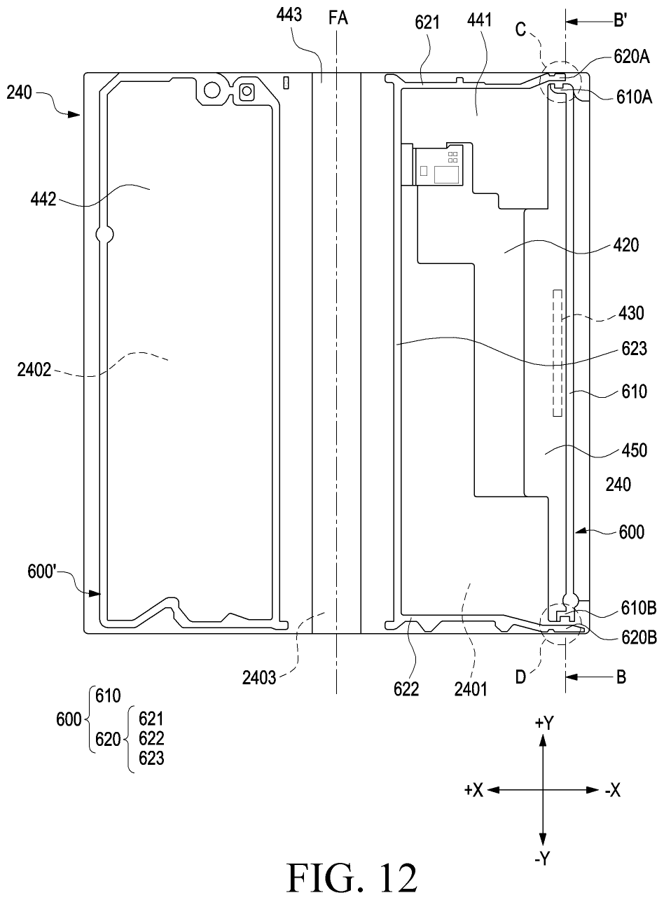

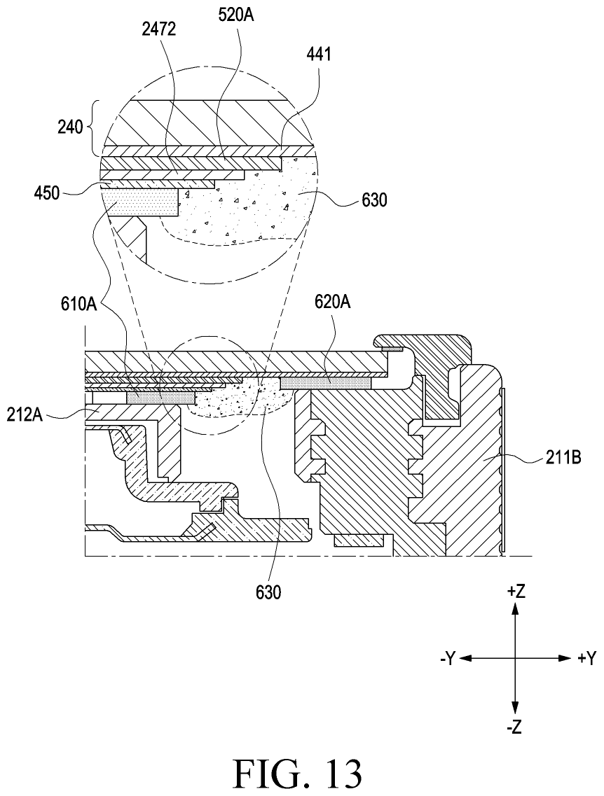

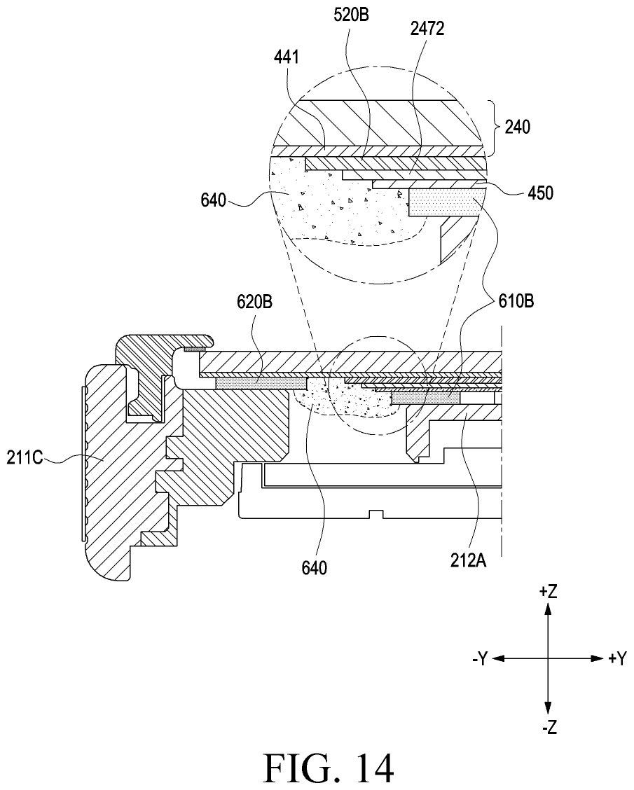

FIG. 11 illustrates a top view of a housing (e.g., the first housing 210 of FIGS. 2 to 4), showing a state in which the waterproof loop 600 is disposed at the first housing 210. FIG. 12 illustrates a bottom view of the display 240, showing the waterproof loops 600 and 600′ together. FIG. 13 is a cross-sectional view taken along line B-B′ of portion C in FIG. 12. FIG. 14 is a cross-sectional view taken along line B-B′ of portion D in FIG. 12.

The waterproof loops 600 and 600′ may be positioned between the support plate 440 and the housings 210 and 220, and may be adhered to both the support plate 440 and the housings 210 and 220, respectively. FIG. 11 illustrates a state in which the waterproof loop 600 is adhered to the first housing 210, while FIG. 12 illustrates a state in which the waterproof loop 600 is adhered to the support plate 440.

Referring to FIGS. 11 to 14, according to an embodiment of the disclosure, the electronic device 200 may include waterproof loops 600 and 600′ extending along the edges of the housings 210 and 220 (e.g., along the side walls 211 and 221 of the housings 210 and 220 (see FIG. 4)). FIGS. 11 to 14 illustrate cases where the waterproof loops 600 and 600′ are respectively disposed. The waterproof loops 600 and 600′ may have a loop shape surrounding the inner space of the housings 210 and 220 to prevent liquid from entering the inner space. The waterproof loop 600 disposed at the first housing 210 and the waterproof loop 600′ disposed at the second housing 220 may have substantially symmetrical shapes with respect to the folding axis FA (see FIG. 2). For convenience of description, the waterproof loop disposed at the first panel portion 441 may be referred to as a first waterproof loop 600, and the waterproof loop disposed at the second panel portion 442 may be referred to as a second waterproof loop 600′.

According to an embodiment of the disclosure, the first housing 210 may include a support bracket 212 disposed below the support plate 440 and supporting the support plate 440. The reinforcement sheet 510 may be positioned between the support bracket 212 and the support plate 440.

According to an embodiment of the disclosure, the support bracket 212 may include a first area 212A and a second area 212B. The first area 212A may be positioned below the extending portion 2405 and may support the extending portion 2405. The second area 212B may be connected to the first area 212A. The first area 212A and the second area 212B may face the bottom surface of the display 240. For example, the second area 212B may support a portion of the support plate 440 which does not overlap the extending portion 2405, and the first area 212A may be recessed relative to the second area 212B.

According to an embodiment of the disclosure, the side wall 211 of the first housing 210 may include a fourth side wall 211D. The first side wall 211A, the second side wall 211B, the third side wall 211C, and the fourth side wall 211D may surround the inner space of the first housing 210. The fourth side wall 211D may extend substantially parallel to the first side wall 211A. The first side wall 211A and the fourth side wall 211D may be connected to each other by the second side wall 211B and the third side wall 211C.

According to an embodiment of the disclosure, the waterproof loop 600 may include a first waterproof segment 610 positioned below the extending portion 2405 of the flexible connection member 410. For example, the first waterproof segment 610 may be adhered between the shielding film 450 covering the extending portion 2405 and the first area 212A of the support bracket 212. The first waterproof segment 610 may extend along the waterproof strip 520. The first waterproof segment 610 may extend along the first side wall 211A. The first waterproof segment 610 may be spaced apart from the waterproof strip 520.

According to an embodiment of the disclosure, the waterproof strip 600 may comprise a second waterproof segment 620 having a first end 620A, and a second end 620B. The first end 620A of the second waterproof strip 620 may be adjacent to each of the first ends 610A, 520A of the first waterproof segment 610 and the waterproof strip 520. The second end 620B of the second waterproof strip 620 may be adjacent to each of the first ends 610B, 520B of the first waterproof segment 610 and the waterproof strip 520.

According to an embodiment of the disclosure, the waterproof loop 600 may include a second waterproof segment 620 configured to form a loop together with the first waterproof segment 610. The second waterproof segment may extend to form at least a portion of the loop together with the first waterproof segment 610. The second waterproof segment 620 may be disposed below the support plate 440 (e.g., the first panel portion 441). For example, the second waterproof segment 620 may be adhered between the first panel portion 441 of the support plate 440 and the second area 212B of the support bracket 212. The second waterproof segment 620 may extend along the second side wall 211B, the third side wall 211C, and the fourth side wall 211D. The second waterproof segment 620 may include a first section 621 extending along the second side wall 211B, a second section 622 extending along the third side wall 211C, and a third section 623 extending along the fourth side wall 211D.

Referring to FIGS. 11 to 14, according to an embodiment of the disclosure, the first waterproof segment 610 and the second waterproof segment 620 may not be disposed on the same plane (e.g., the XY plane). The ends 610A and 610B of the first waterproof segment 610 and the ends 620A and 620B of the second waterproof segment 620 may be connected by gaskets 630 and 640, and a closed-loop waterproof loop 600 may be formed by the first waterproof segment 610, the second waterproof segment 620, and the waterproof gaskets 630 and 640. The second waterproof segment 620 may extend from the waterproof gaskets 630 and 640.

According to an embodiment of the disclosure, the waterproof loop 600 may include waterproof gaskets 630 and 640 connecting the ends 610A and 610B of the waterproof strip 610 to the ends 620A and 620B of the first waterproof segment 620, respectively. For example, the waterproof gaskets 630 and 640 may be cured-in-place gaskets (CIPG) which are injected at specific positions and then cured. For convenience of description, the gasket connecting the first end 610A of the first waterproof segment 610 and the first end 620A of the second waterproof segment 620 may be referred to as a first waterproof gasket 630, and the gasket connecting the second end 610B of the first waterproof segment 610 and the second end 620B of the second waterproof segment 620 may be referred to as a second waterproof gasket 640.

According to an embodiment of the disclosure, the waterproof loop 600 may comprise a first waterproof gasket 630 connecting the first ends 520A, 610A, 620A of the waterproof strip 520, the first waterproof segment 610, and the second waterproof segment 620 to each other. The waterproof loop 600 may comprise a second waterproof gasket 630 connecting the second ends 520B, 610B, 620B of the waterproof strip 520, the first waterproof segment 610, and the second waterproof segment 620 to each other.

According to an embodiment of the disclosure, the ends 520A and 520B of the waterproof strip 520 may be connected to the waterproof gaskets 630 and 640. A closed-loop may be formed by the waterproof strip 520, the second waterproof segment 620, and the waterproof gaskets 630 and 640. The reinforcement sheet 510 may be positioned outside the closed-loop formed by the waterproof strip 520, the second waterproof segment 620, the first waterproof gaskets 630, and the second waterproof gasket 640. The reinforcement sheet 510 may overlap the first waterproof segment 610 when viewed from above the display (e.g., the display panel 240D).

Referring to FIGS. 7 to 9 and FIGS. 11 to 14, according to an embodiment of the disclosure, the flexible connection member 410 extending from the display 240 (see FIGS. 7 to 9) may pass between the waterproof strip 520 and the first waterproof segment 610. The extending portion 2405 of the flexible connection member 410 may be positioned between the waterproof strip 520 and the first waterproof segment 610.

According to an embodiment of the disclosure, the ends 520A and 520B of the waterproof strip 520 may protrude further than the end of the extending portion 2405 of the flexible connection member 410 (or the end of the second protective film 2472). Referring to FIGS. 13 and 14, the waterproof gaskets 630 and 640 may be in contact with the ends 520A and 520B of the waterproof strip 520 and may also be in contact with the end of the extending portion 2405 or the end of the second protective film 2472.

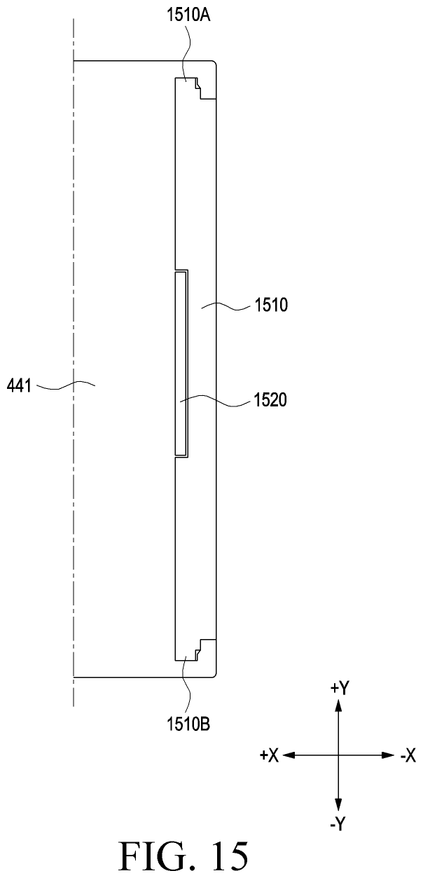

FIG. 15 illustrates a reinforcement sheet 1510 and a waterproof strip 1520 according to an embodiment of the disclosure. FIG. 15 illustrates a bottom view of the first panel portion 441 of the support plate 440.

The descriptions of the components described with reference to FIGS. 6 to 14 (e.g., the reinforcement sheet 510, the ends 510A and 510B of the reinforcement sheet 510, and the waterproof strip 520) may be substantially equally applicable to components with the same names described with reference to FIG. 15 (e.g., the reinforcement sheet 1510, the ends 1510A and 1510B of the reinforcement sheet 1510, the waterproof strip 1520), to the extent that they are not contradictory to each other.

According to an embodiment of the disclosure, the display drive integrated circuit 430 (see FIG. 6) may be positioned below the waterproof strip 1520. When viewed from above the display 240 (e.g., the first display area 241 or the display panel 240D), the display drive integrated circuit 430 may overlap the waterproof strip 1520. When viewed from above the display 240 (e.g., the first display area 241 or the display panel 240D), the display drive integrated circuit 430 may not overlap the reinforcement sheet 510. Accordingly, by disposing the display drive integrated circuit 430 to overlap the waterproof strip 1520, which has relatively low rigidity, the waterproof strip 1520 may serve as a buffer to protect the display drive integrated circuit 430 when an external impact is applied to the display 240.

According to an embodiment of the disclosure, the waterproof loop 600 may comprise the second waterproof segment 620 having the first end 620A adjacent to first ends 610A, 1510A of each of the first waterproof segment 610 and the reinforcement sheet 1510, and the second end 620B adjacent to second ends 610B, 1510B of each of the second waterproof segment 610 and the reinforcement sheet 1510. The waterproof loop 600 comprises the first waterproof gasket 630 connecting the first ends 1510A, 610A, 620A of the reinforcement sheet 1510, the first waterproof segment 610, and the second waterproof segment 620 to each other. The waterproof loop 600 comprises the second waterproof gasket 640 connecting the second ends 1510B, 610B, 620B of the reinforcement sheet 1510, the first waterproof segment 610, and the second waterproof segment 620 to each other.

According to an embodiment of the disclosure, the ends 1510A and 1510B of the reinforcement sheet 1510 may be connected to the waterproof gaskets 630 and 640 (see FIGS. 13 and 14). Accordingly, the reinforcement sheet 1510, the second waterproof segment 620 (see FIG. 12), and the waterproof gaskets 630 and 640 may form a single closed loop. The waterproof gaskets 630 and 640 may connect the ends 1510A and 1510B of the reinforcement sheet 1510 to the ends 610A the 610B of the first waterproof segment 610. Thus, the first waterproof segment 610 (see FIG. 12), the second waterproof segment 620, the first waterproof gaskets 630, and the second waterproof gasket 640 may form a single closed loop.

FIG. 16 is an exploded perspective view of the electronic device 101 viewed from above, according to an embodiment of the disclosure. FIG. 17 is an exploded perspective view of the electronic device 101 viewed from below, according to an embodiment of the disclosure.

The description of the electronic device 101 described with reference to FIG. 1 may be substantially equally applicable to the electronic device 101 described with reference to FIGS. 16 and 17, to the extent that they are not contradictory to each other. The descriptions of the components described with reference to FIGS. 2 to 15 (e.g., the first housing 210, the side wall 211 of the first housing 210, the support bracket 212 of the first housing 210, the display 240, and/or the flexible connection member 410) may be substantially equally applicable to components with the same names described with reference to FIGS. 16 and 17 (e.g., the housing 301, the side wall 310 of the housing 301, the support bracket 311 (or the first support bracket 311) of the housing 301, the display 330, and/or the flexible connection member 390), to the extent that they are not contradictory to each other.

Referring to FIGS. 16 and 17, according to an embodiment of the disclosure, the electronic device 101 may include a housing 301 forming at least a portion of the exterior of the electronic device 101. The housing 301 may include a side wall 310 and a first support bracket 311. The electronic device 101 may include a front surface plate 320, a display 330, one or more printed circuit boards (or a circuit board assembly) 340a and 340b, a battery 350, a second support bracket 360 (e.g., a rear case), a camera assembly 307, and/or a rear surface plate 380 (e.g., the rear surface plate 211 of FIG. 2).

According to an embodiment of the disclosure, when including multiple printed circuit boards 340a and 340b, the electronic device 101 may include at least one flexible printed circuit board 340c to electrically connect different printed circuit boards. For example, the printed circuit boards 340a and 340b may include a first circuit board 340a positioned above the battery 350 and a second circuit board 340b positioned below the battery 350, and a flexible printed circuit board 340c may electrically connect the first circuit board 340a and the second circuit board 340b.

According to an embodiment of the disclosure, the electronic device 101 may exclude at least one of the components (e.g., the first support bracket 311 or the second support bracket 360), or may additionally include other components. At least one of the components of the electronic device 101 may be the same as or similar to at least one of the components of the electronic device 101 of FIG. 1 or FIG. 2, and a redundant description thereof is omitted below.

According to an embodiment of the disclosure, at least one portion of the first support bracket 311 may be provided in a planar shape. In an embodiment, the first support bracket 311 may be disposed inside the electronic device 101 to be connected to the side wall 310 or may be integrated with the side wall 310. The first support bracket 311 may support the display 330. A processor (e.g., the processor 120 of FIG. 1), a memory (e.g., the memory 130 of FIG. 1), and/or an interface (e.g., the interface 177 of FIG. 1) may be mounted on the printed circuit boards 340a and 340b.

According to an embodiment of the disclosure, the support bracket 311 may face the front surface plate 320. The support bracket 311 may face the rear surface plate 380. The support bracket 311 may provide a space in which the battery 350 or the printed circuit boards 340a and 340b are disposed.

According to an embodiment of the disclosure, the display 330 may be supported by the support bracket 311. The description of the display 240 described with reference to FIG. 5 may be substantially equally applicable to the display 330. The electronic device 101 may include a flexible connection member 390 which extends from an edge of the display 330 and is bent toward a space below the edge of the display 330. The display 330 may be connected to the circuit board 340a inside the electronic device 101 via the flexible connection member 390.

According to an embodiment of the disclosure, the front surface plate 320 may be referred to as a “cover” or a “front surface cover.” The rear surface plate 380 may be referred to as a “cover” or a “rear surface cover.” The cover 380 may face the support bracket 311. According to an embodiment of the disclosure, the second support bracket 360 may include, for example, an upper support bracket 360a and a lower support bracket 360b. In an embodiment, the upper support bracket 360a may be disposed to enclose the printed circuit boards 340a and 340b (e.g., the first circuit board 340a) together with a portion of the first support bracket 311. For example, the upper support bracket 360a of the second support bracket 360 may be positioned to face the first support bracket 311 with the first circuit board 340a interposed therebetween. In an embodiment, the lower support bracket 360b of the second support bracket 360 may be positioned to face the first support bracket 311 with the second circuit board 340b interposed therebetween.

Circuit devices implemented in the form of integrated circuits (e.g., a processor, a communication module, or memory) and various electrical/electronic components may be disposed on the printed circuit boards 340a and 340b. Depending on the embodiment, the printed circuit boards 340a and 340b may be provided with an electromagnetic shielding environment by the second support bracket 360. In an embodiment, the lower support bracket 360b may be used as a structure on which an electric/electronic component such as a speaker module or an interface (e.g., a USB connector, an SD card/MMC connector, or an audio connector) may be disposed. In an embodiment, an electrical/electronic component, such as a speaker module or an interface (e.g., a USB connector, an SD card/MMC connector, or an audio connector), may be disposed on an additional printed circuit board (not illustrated). For example, the lower support bracket 360b may be disposed to enclose the additional printed circuit board together with the other portion of the first support bracket 311.

According to an embodiment of the disclosure, the battery 350 is a device which supplies power to at least one component of the electronic device 101, and may include, for example, a non-rechargeable primary battery, a rechargeable secondary battery, or a fuel cell. At least a portion of the battery 350 may be disposed on substantially the same plane as, for example, the printed circuit boards 340a and 340b. The battery 350 may be integrally disposed inside the electronic device 101 or may be detachably disposed on the electronic device 101.

According to an embodiment of the disclosure, the camera assembly 307 may include at least one camera module. Inside the electronic device 101, the camera assembly 307 (or at least one camera module) may receive at least a portion of light incident through an optical hole or a camera window 312, 313, or 319. In an embodiment, the camera assembly 307 may be disposed on the support bracket 311 at a position adjacent to the printed circuit board 340a or 340b. In an embodiment, the camera modules of the camera assembly 307 may be generally aligned with one of the camera windows 312, 313, and 319, and may be at least partially enclosed by the second support bracket 360 (e.g., the upper support bracket 360a).

The reinforcement sheets 510 and 1510 and the waterproof strips 520 and 1520 described with reference to FIGS. 6 to 15 may be substantially equally applicable to the electronic device 101 described with reference to FIGS. 16 and 17. For example, the reinforcement sheets 510 and 1510 and the waterproof strips 520 and 1520 described with reference to FIGS. 6 to 15 may be disposed between the flexible connection member 390 of the electronic device 101 illustrated in FIGS. 16 and 17 and the edge of the display 330 where the flexible connection member 390 extends, thereby reinforcing the rigidity of the edge of the display 330.

In order to make electronic devices thinner and/or lighter, the thickness and weight of displays placed at electronic devices are being reduced. For example, the thickness and/or weight of a display may be reduced by manufacturing the display panel included in the display, the protective window covering the display panel, or the support plate supporting the display panel to be thinner, or by changing the material of these components. However, a thinner and/or lighter display fabricated through the above methods may be more vulnerable to deformation or damage when an external impact is applied to the electronic device. Accordingly, extensive research is being conducted on methods for ensuring the structural stability of the display while allowing for the thinning and/or weight reduction of the display.

An issue to be addressed by the present disclosure may be to reinforce the rigidity of an edge region of a display without increasing the thickness of the display.

Another issue to be addressed by the present disclosure may be to minimize damage to components around a reinforcement member (e.g., the display drive integrated circuit) due to the reinforcement member.

The issues that the disclosure seeks to address are not limited to the aforementioned issued, and may be expanded in various ways without departing from the spirit and scope of the disclosure.

According to various embodiments of the disclosure, by disposing a reinforcement sheet to support the edge region of the display, the rigidity of the edge region of the display may be reinforced without increasing the thickness of the display.

According to various embodiments of the disclosure, by disposing a reinforcement member for reinforcing the rigidity of the edge region of the display at a location spaced apart from structurally vulnerable components (e.g., the display drive integrated circuit), damage to the vulnerable components due to the rigidity of the reinforcement sheet may be minimized.

The effects that are capable of being obtained by the disclosure are not limited to those described above, and other effects not described above may be clearly understood by a person ordinarily skilled in the art to which the disclosure belongs based on the aforementioned description.

According to an embodiment of the disclosure, an electronic device 200 (e.g., the electronic device 101 of FIGS. 16 and 17) may include a first housing 210 (e.g., the set housing 201 of FIGS. 2 to 4) forming at least a portion of the exterior of the electronic device 200.

According to an embodiment of the disclosure, the electronic device 200 may include a display 240 disposed on the first housing 210.

According to an embodiment of the disclosure, the display 240 may include a display panel 240D.

According to an embodiment of the disclosure, the display 240 may include a support plate 440 disposed below the display panel 240D and supporting (or facing) the display panel 240D.

According to an embodiment of the disclosure, the support plate 440 may comprise a peripheral portion adjacent to the edge of the display panel 240D.

According to an embodiment of the disclosure, the electronic device 200 may include a flexible connection member 410.

According to an embodiment of the disclosure, the flexible connection member 410 may include a flexible portion 2404 bent from an edge of the display panel 240D.

According to an embodiment of the disclosure, the flexible connection member 410 may include an extending portion 2405 extending from the flexible portion 2404 and positioned below the support plate 440 (e.g., the peripheral portion).

According to an embodiment of the disclosure, the electronic device 200 may include a waterproof strip 520 positioned between the extending portion 2405 and an edge (e.g., the peripheral portion) of the support plate 440.

According to an embodiment of the disclosure, the waterproof strip 520 may extend along the edge (e.g., the peripheral portion) of the support plate 440.

According to an embodiment of the disclosure, the electronic device 200 may include a reinforcement sheet 510 positioned between the extending portion 2405 and the edge of the support plate 440.

According to an embodiment of the disclosure, the reinforcement sheet 510 may extend along the waterproof strip 520.

According to an embodiment of the disclosure, the reinforcement sheet 510 may include a reinforcement material having a rigidity higher than that of the waterproof strip 520.

According to an embodiment of the disclosure, the reinforcement sheet 510 may be positioned between the flexible portion 2404 and the waterproof strip 520, in a direction along the display panel.

According to an embodiment of the disclosure, the waterproof strip 520 is further from the peripheral portion of the support plate 440 than the reinforcement sheet 510.

According to an embodiment of the disclosure, the electronic device 200 may include a display drive integrated circuit 430 electrically connected to the display panel 240D through the flexible connection member 410.

According to an embodiment of the disclosure, along a thickness direction of the display panel, the waterproof strip 520 may be positioned between the display drive integrated circuit 430 and the waterproof strip 520.

According to an embodiment of the disclosure, when viewed from above the display panel 240D, the display drive integrated circuit 430 may overlap the waterproof strip 520 and may not overlap the reinforcement sheet 510.

According to an embodiment of the disclosure, the electronic device 200 may include a waterproof loop 600 extending along an edge of the first housing 210.

According to an embodiment of the disclosure, the waterproof loop 600 may include a first waterproof segment 610 disposed below the extending portion 2405 of the flexible connection member 410 and extending along the waterproof strip 520.

According to an embodiment of the disclosure, the first waterproof segment 610 may be spaced apart from the waterproof strip 520.

According to an embodiment of the disclosure, the waterproof strip 600 may comprise a second waterproof segment 620 having a first end 620A adjacent to each of the first ends 610A, 520A of the first waterproof segment 610 and the waterproof strip 520, and a second end 620B adjacent to each of the first ends 610B, 520B of the first waterproof segment 610 and the waterproof strip 520.

According to an embodiment of the disclosure, the waterproof segment 620 may extend to form at least a portion of a loop together with the first waterproof segment 610.

According to an embodiment of the disclosure, the waterproof loop 600 may include a first waterproof gasket 630 connecting first ends 520A, 610A, 620A of the waterproof strip 520, the first waterproof segment 610, and the second waterproof segment 620 to each other. According to an embodiment of the disclosure, the waterproof loop 600 may include a second waterproof gasket 640 connecting second ends 520B, 610B, 620B of the waterproof strip 520, the first waterproof segment 610, and the second waterproof segment 620 to each other.

According to an embodiment of the disclosure, the waterproof loop 600 may include a second waterproof segment 620 extending from the waterproof gasket 630 or 640 and configured to form a loop together with the first waterproof segment 610.

According to an embodiment of the disclosure, the reinforcement sheet 510 may be positioned outside the loop formed by the waterproof strip 520, the second waterproof segment 620, the first waterproof gasket 630, the second waterproof gasket 640.

According to an embodiment of the disclosure, when viewed from above the display panel 240D, the reinforcement sheet 510 may overlap the first waterproof segment 610.

According to an embodiment of the disclosure, the reinforcement sheet 510 may have a first end 510A and a second end 510B corresponding to a first end 520A and a second end 520B of the waterproof strip 520.

According to an embodiment of the disclosure, when viewed from above the display 240, the first end 520A and the second end 520B of the waterproof strip 520 may partially surround the first end 510A and the second end 510B of the reinforcement sheet 510, respectively.

According to an embodiment of the disclosure, the waterproof gaskets 630 and 640 may connect the ends 1510A and 1510B of the reinforcement sheet 1510 to the ends 610A and 610B of the first waterproof segment 610.

According to an embodiment of the disclosure, the waterproof loop 600 may comprise the second waterproof segment 620 having the first end 620A adjacent to first ends 610A, 1510A of each of the first waterproof segment 610 and the reinforcement sheet 1510, and the second end 620B adjacent to second ends 610B, 1510B of each of the second waterproof segment 610 and the reinforcement sheet 1510.

According to an embodiment of the disclosure, the waterproof loop 600 comprises the first waterproof gasket 630 connecting the first ends 1510A, 610A, 620A of the reinforcement sheet 1510, the first waterproof segment 610, and the second waterproof segment 620 to each other.

According to an embodiment of the disclosure, the waterproof loop 600 comprises the second waterproof gasket 640 connecting the second ends 1510B, 610B, 620B of the reinforcement sheet 1510, the first waterproof segment 610, and the second waterproof segment 620 to each other.

According to an embodiment of the disclosure, when viewed from above the display panel 240D, the display drive integrated circuit 430 may overlap the waterproof strip 1520 and may not overlap the reinforcement sheet 1510.

According to an embodiment of the disclosure, the first housing 210 may include a support bracket 212 (plate portion) disposed below the support plate 440 and supporting the support plate 440.

According to an embodiment of the disclosure, the reinforcement sheet 510 may be positioned between the support bracket 212 (the plate portion) of the first housing 210 and the support plate 440 of the display 240.

According to an embodiment of the disclosure, the support bracket 212 (the plate portion) of the first housing 210 may include a first area 212A positioned below the extending portion 2405 and supporting (or overlapping) the extending portion 2405.

According to an embodiment of the disclosure, the support bracket 212 may include a second area 212B connected to the first area 212A.

According to an embodiment of the disclosure, the second aera 212B of the support bracket 212 may overlap the support plate 440, and may not overlap the extending portion 2405.

According to an embodiment of the disclosure, the first area 212A may be recessed relative to the second area 212B.

According to an embodiment of the disclosure, the reinforcement sheet 510 may include a reinforcement layer 513 including the reinforcement material.

According to an embodiment of the disclosure, the reinforcement sheet 510 may include an adhesive layer 511 (e.g., the first adhesive layer 511 of the reinforcement sheet 510) adhering the reinforcement layer 513 to the support plate 440 of the display 240.

According to an embodiment of the disclosure, the waterproof strip 520 may include an elastic layer 523 having a rigidity lower than that of the reinforcement layer 513 and an elasticity higher than that of the reinforcement layer 513.

According to an embodiment of the disclosure, the waterproof strip 520 may include an adhesive layer 521 (e.g., the first adhesive layer 521 of the waterproof strip 520) bonding the elastic layer 523 to the support plate 440 of the display 240.

According to an embodiment of the disclosure, the support plate 440 of the display 240 may include a rigid material having a density lower than that of the reinforcement material.

According to an embodiment of the disclosure, the reinforcement material may have a yield strength higher than that of the rigid material.

Although the disclosure has been described with reference to various embodiments as an example, it is to be understood that various embodiments are intended to be exemplary and not to limit the disclosure. It will be apparent to those skilled in the art that various changes in form and detail may be made without departing from the overall scope of the disclosure, including the appended claims and their equivalents.

What is claimed is:

1. An electronic device comprising:
a housing forming at least a portion of an exterior of the electronic device;
a display disposed on the housing and comprising a display panel and a support plate, which is disposed below the display panel and faces the display panel, wherein the support plate has a peripheral portion adjacent to an edge of the display panel;
a flexible connection member comprising a flexible portion, which is bent from the edge of the display panel, and an extending portion, which extends from the flexible portion and is positioned below the peripheral portion of the support plate;
a reinforcement sheet disposed between the extending portion and the peripheral portion of the support plate and extending along the peripheral portion of the support plate; and
a waterproof strip disposed between the extending portion and the peripheral portion of the support plate and extending along the reinforcement sheet,
wherein the reinforcement sheet comprises a reinforcement material having a rigidity higher than a rigidity of the waterproof strip.

2. The electronic device of claim 1, wherein the reinforcement sheet is between the flexible portion and the waterproof strip, in a direction along the display panel, and the waterproof strip is further from the peripheral portion of the support plate than the reinforcement sheet.

3. The electronic device of claim 1, further comprising a display drive integrated circuit electrically connected to the display panel via the flexible connection member,
wherein along a thickness direction of the display panel, the waterproof strip is between the display drive integrated circuit and the support plate.

4. The electronic device of claim 3, wherein when viewed from above the display panel, the display drive integrated circuit overlaps the waterproof strip and does not overlap the reinforcement sheet.

5. The electronic device of claim 1, further comprising a waterproof loop extending along an edge of the housing, wherein the waterproof loop comprises:
a first waterproof segment which is below the extending portion of the flexible connection member, extends along the waterproof strip and is spaced apart from the waterproof strip, wherein each of the first waterproof segment and the waterproof strip has a first end and a second end opposing each other;
a second waterproof segment which has a first end adjacent to the first ends of the first waterproof segment and the waterproof strip and a second end adjacent to the second ends of the first waterproof segment and the waterproof strip, and extends to form at least a portion of a loop together with the first waterproof segment;
a first waterproof gasket connecting the first ends of the first waterproof segment, the second waterproof segment, and the waterproof strip to each other; and
a second waterproof gasket connecting the second ends of the first waterproof segment, the second waterproof segment, and the waterproof strip to each other.

6. The electronic device of claim 5, wherein
the reinforcement sheet is positioned outside a loop formed by the waterproof strip, the second waterproof segment, the first waterproof gasket, and the second waterproof gasket.

7. The electronic device of claim 5, wherein when viewed from above the display panel, the reinforcement sheet overlaps the first waterproof segment.

8. The electronic device of claim 5, wherein
the reinforcement sheet has a first end and a second end corresponding to the first end and the second end of the waterproof strip, respectively; and
when viewed from above the display panel, the first end and the second end of the waterproof strip partially surrounds the first end and the second end of the reinforcement sheet, respectively.

9. The electronic device of claim 1, further comprising a waterproof loop extending along an edge of the housing, wherein the waterproof loop comprises:
a first waterproof segment which is below the extending portion of the flexible connection member, extends along the reinforcement sheet and is spaced apart from the reinforcement sheet, wherein each of the first waterproof segment and the reinforcement sheet has a first end and a second end opposing each other;
a second waterproof segment which has a first end adjacent to the first ends of the first waterproof segment and the reinforcement sheet and a second end adjacent to the second ends of the first waterproof segment and the reinforcement sheet, and extends to form at least a portion of a loop with the first waterproof segment;
a first waterproof gasket connecting the first ends of the first waterproof segment, the second waterproof segment, and the reinforcement sheet to each other; and
a second waterproof gasket connecting the second ends of the first waterproof segment, the second waterproof segment, and the reinforcement sheet to each other.

10. The electronic device of claim 9, wherein when viewed from above the display panel, the display drive integrated circuit overlaps the waterproof strip and does not overlap the reinforcement sheet.

11. The electronic device of claim 1, wherein
the housing comprises a plate portion which is below and overlapping the display, and
the reinforcement sheet is between the plate portion of the housing and the support plate of the display.

12. The electronic device of claim 11, wherein the plate portion of the housing comprises:
a first area below and overlapping the extending portion of the flexible connection member; and
a second area which is connected to the first area, overlaps the support plate of the display and does not overlap the extending portion of the flexible connection member; and
wherein the first area is recessed relative to the second area.

13. The electronic device of claim 1, wherein the reinforcement sheet comprises:
a reinforcement layer comprising the reinforcement material having the rigidity higher than the rigidity of the waterproof strip; and
a first adhesive layer which adheres the reinforcement layer to the support plate of the display.

14. The electronic device of claim 13, wherein the waterproof strip comprises:
an elastic layer having a rigidity lower than a rigidity of the reinforcement layer, and an elasticity higher than an elasticity of the reinforcement layer; and
a second adhesive layer which adheres the elastic layer to the support plate of the display.

15. The electronic device of claim 14, wherein
the support plate of the display comprises a rigid material having a density lower than a density of the reinforcement material; and
a yield strength of the reinforcement material is higher than a yield strength of the rigid material.

16. An electronic device comprising:
a housing forming a portion of an exterior of the electronic device;
a display on the housing, the display comprising:
a display panel having an edge, and
a support plate which faces the display panel, is below the display panel and has an edge adjacent to the edge of the display panel;
a flexible connection member connected to the display panel, the flexible connection member comprising:
a flexible portion which extends bent from the edge of the display panel, and
an extending portion which extends from the flexible portion and is below the support plate;
between the extending portion of the flexible connection member and the support plate of the display:
a reinforcement sheet extending along the edge of the display panel; and
a waterproof strip which is further from the edge of the support plate than the reinforcement sheet and extends along the reinforcement sheet,
wherein the reinforcement sheet comprises a material having a rigidity higher than a rigidity of the waterproof strip, and is between the waterproof strip and the flexible portion of the flexible connection member; and
a display drive integrated circuit electrically connected to the display panel via the flexible connection member, the waterproof strip being between the display drive integrated circuit and the support plate.

17. The electronic device of claim 16, wherein
the housing comprises a support plate below and overlapping the display, and
the reinforcement sheet is between the support plate of the housing and the support plate of the display.

18. The electronic device of claim 17, wherein the support plate of the housing comprises:
a first area below and overlapping the extending portion of the flexible connection member;
a second area which is connected to the first area, overlaps the support plate of the display and does not overlap the extending portion of the flexible connection member; and
the first area is recessed relative to the second area.

19. The electronic device of claim 16, wherein the reinforcement sheet comprises:
a reinforcement layer comprising the reinforcement material having the rigidity higher than the rigidity of the waterproof strip;
a first adhesive layer which adheres the reinforcement layer to the support plate, at a first surface of the reinforcement layer; and
a second adhesive layer adhered to a second surface of the reinforcement layer which is opposite to the first surface.

20. The electronic device of claim 19, wherein the waterproof strip comprises an elastic layer having a rigidity lower than that of the reinforcement layer of the reinforcement sheet and an elasticity higher than that of the reinforcement layer of the reinforcement sheet.
